(19) United States
(12) Patent Application Publication
(10) Pub. No.: US 2004/0146039 A1
(43) Pub. Date: Jul. 29, 2004

(54) Method for session management parameter activation for a subscriber terminal of a communication network

(76) Inventors: Jonne Soininen, Helsinki (FI); Ahti Muhonen, Hirvihaara (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/478,851

(22) PCT Filed: May 30, 2001
(86) PCT No.: PCT/EP01/06168

(51) Int. Cl. H04J 3/24

(52) U.S. Cl. 370/349

(57) ABSTRACT

The present invention relates to a method for session management parameter activation for a subscriber terminal to a communication network, the communication network comprising an access network via which said terminal accesses a core network, the core network being independent of the connection technology of the access network, said session management parameter comprises at least a network layer address of said subscriber terminal, the method comprising the steps of: informing (S11) an access network node of a request for a session management parameter activation, detecting (S12) at said access network node that said informed requested session management parameter activation relates to a specific type of session management parameter, and in response thereto, allocating (S14) a network layer address for said subscriber terminal from an address space maintained at said access network node.

### FIELD OF THE INVENTION

The present invention relates to a method for session management parameter activation for a subscriber terminal of a communication network.

### BACKGROUND OF THE INVENTION

As a result of recent developments in connection with communication networks, a network architecture is adopted according to which the entire network is partitioned in an access network AN via which a subscriber terminal (known as mobile station in GSM and/or 2G GPRS [GSM=Global System of Mobile Communication, 2G=2^{nd} Generation, GPRS=General Packet Radio Service], or as user equipment UE in UMTS and/or 3G GPRS [UMTS=Universal Mobile Telecommunications System, 3G=3^{rd} Generation) accesses a core network CN. Note that in such architectures the core network CN is independent of the connection technology of the access network AN.

For example, according to UMTS, -an access network comprises at least one Node_B (corresponding to a base station BS in GSM) under control of a radio network controller RNC (corresponding to a base station controller BSC in GSM). Dependent on the size of the network, of course more than one RNC may be present, so that a RNC controlling a Node_B currently serving the terminal and said Node_B may be referred to as Serving Radio Network Subsystem SRNS.

With regard to the core network entities, reference is only made to those entities provided for connection with packet switched networks, which perform data transmission on a basis of packets, such as GPRS. Thus, the GPRS core network part comprises at least one serving GPRS support node SGSN, connected to a gateway GPRS support node GGSN. The GGSN provides for a possibility to establish a connection to the “outside” of the GPRS network, e.g. to the Internet. The GGSN is also adapted to query a register entity of the core network in which subscriber data are kept. According to 3G UMTS specification, such a register entity is referred to as home subscriber server HSS (corresponding to a home location register HGLR in GSM).

Since those skilled in the art are -familiar with current communication network architectures and the functional entities involved, a further detailed description thereof is considered to be dispensable in this application. For example only, further details of architectural principles and functional interrelations could be found in 3GPP (3^{rd} Generation Partnership Project) document TR 23.821, V1.0.0 (2000-06).

In order to communicate with a communication partner, the subscriber of the (wired or wireless) terminal may initiate a call as a logical association between , in general, several users, i.e. the subscriber and at least one communication partner. Such a call may be connection oriented or connection less, a connection referring to a communication channel between two or more end-points.

A logical association as mentioned before may also be referred to as a session. A session in turn is specified by at least one session management parameter, which for establishing communication, has to be activated.

The expression session management parameter as used in the present application has to be understood in its broadest sense without any limitation to a specific one of such session management parameter(s).

However, in order to support the comprehensibility of the subsequent explanation of the present invention, reference is made for explanatory purposes to specific examples of such session management parameters to be activated.

Generally, session management parameters are defined for an external packet data network address (e.g. the terminal's address) and are necessary to achieve data transfer between SGSN's at an inter SGSN routing update procedure. The session managament parameters form at least part of a context information element, which in a specifically chosen example, is known as PDP (PDP=packet data protocol) context activation element. At least one but normally plural of such PDP context information elements form one or more information sets held in the terminal (e.g. UE) and GPRS support nodes GGSN's for a PDP address. These information sets are known as PDP context. Note that PDP represent the packet Data Protocol used as an example for the present explanations and is not intended to be limiting for the present invention. The PDP is a network protocol used by an external packet data network (such as for example the Internet) interfacing to the GPRS network. The PDP address mentioned before means that a GPRS subscriber (e.g. the terminal UE) identified by at least its IMSI (International Mobile Subscriber Identity) shall have one or more network layer addresses, i.e. PDP addresses, temporarily/permanently associated with it that conforms to the addressing scheme of the respective network layer service used. Services used may vary dependent on the network layer, but generally, services can be regarded as upper layer applications provided for a subscriber.

Further, a PDP context (PDP=packet data protocol) is defined by the PDP type, the address (of the user, i.e. the terminal), and certain quality of service requirements for said application (QoS). The PDP type identifies the type of the protocol. At present, PDP types defined so far may specify for example the IPv4, IPv6, SIP or WAP protocol (IP=Internet Protocol, version 4 and/or 6, SIP=Session Initiation Protocol, WAP=Wireless Application Protocol).

In case of a moving terminal, mobility of the terminal has to be supported by the network in order that a call/connection may not be interrupted due to the terminal's movement within the network. Currently, the mobility provided for terminals by the use of for example the IP protocol (Mobile IP) or the SIP protocol is supported transparently over the UMTS access networks, i.e. RAN (Radio Access Network) or UTRAN (UMTS Terrestrial RAN).

This in turn , however, leads to the fact that the full capabilities of mobility management external to the core network remains unused.

### SUMMARY OF THE INVENTION

Hence, it is an object of the present invention to improve the known mobility management schemes. More precisely, the present invention aims to provide a method for session management parameter activation for a subscriber terminal of a communication network which is not restricted to the mobility management (MM) capabilities of the core network CN.

According to the present invention this object is for example achieved by a method for session management parameter activation for a subscriber terminal of a communication network, the communication network comprising an access network via which said terminal accesses a core network, the core network being independent of the connection technology of the access network, said session management parameter comprises at least a network layer address of said subscriber terminal, the method comprising the steps of: informing an access network node of a request for a session management parameter activation, detecting at said access network node that said informed requested session management parameter activation relates to a specific type of session management parameter, and in response thereto, allocating a network layer address for said subscriber terminal from an address space maintained at said access network node.

According to favorable further developments of the present invention:

said step of informing comprises receiving a session management parameter activation request from a terminal;

said step of informing comprises receiving an indication for a session management parameter activation request from a core network node;

said access network node is a radio network controller (RNC);

said core network node is a serving GPRS support node (SGSN);

said session management parameter activation request comprises at least the type of said session management parameter, and said step of detecting comprises verifying that said received type of said requested session parameter activation is said specific type;

said received indication confirms that said requested session parameter activation is related to said specific type;

said indication is obtained as a result of an inquiry (S23, S24) to a subscriber information database entity and indicates that the requested type is allowed for the requesting subscriber;

said session management parameter is a PDP context for said subscriber terminal.

By virtue of the present invention being thus implemented, the use of the full capabilities of mobility management external to the core network is thus enabled.

Still further, the required signaling for session management parameter activation could be simplified by allocating the network layer address already at an access network node. In particular, in a specific embodiment, the whole core network could be “by-passed” when allocating a network layer address to the session management parameter to be activated. This may even be implemented without the necessity to query a user information database.

In case of querying a user information database in a second (and/or third) embodiment, the activation of the requested session management parameter activation could be confirmed and reliability of the activation for the specific requesting user could thus be enhanced.

Furthermore, the processing load for subscriber mobility management on the core network could be reduced by shifting the load dependent on the detected type of session management parameter to the access network.

### BRIEF DESCRIPTION OF THE DRAWINGS

The present invention will be more readily understood upon referring to the following detailed description thereof when read in conjunction with the accompanying drawings, in which:

FIG. 1 illustrates a signaling scenario according to a first embodiment of the present invention, and

FIG. 2 illustrates a signaling scenario according to a second embodiment of the present invention.

### DETAILED DESCRIPTION OF THE EMBODIMENTS

Embodiments of the present invention will subsequently be described in detail with reference to the drawings.

Basically, according to the solution as proposed according to the present invention, a new PDP Type is added to existing ones, which new PDP type allows the usage of external mobility management schemes to the full extent. This new PDP Type would make the SRNS, more precisely, an entity and/or node of the radio access network, to allocate the network layer address, e.g. IP address, the PDP address, of the PDP context.

In addition, according to the embodiments of the present invention described hereinafter, the RNC is about to allocate the IP Address (first embodiment) or the SGSN is about to instruct the RNC to allocate the IP address (second embodiment) from the RNC address space. This would not prevent the MS from using normal PDP Contexts having GTP mobility management in addition (GTP=GPRS Tunneling Protocol).

Furthermore, even a combination of features of the first and second embodiments is conceivable as a third embodiment outlined below.

Accordingly, with the new way to access non-core network 3GPP mobility management/network as presented by the presented invention, it is possible to have and/or to handle “PDP Context” already in the RNC (i.e. the IP address (PDP address) is allocated from RNC's address space), thus by-passing the whole 3GPP Core Network (comprising e.g. SGSN, GGSN) in terms of IP address allocation.

This will be described in greater detail with reference to the embodiments of the present invention.

### First Embodiment

RNC intercepts the Activate PDP Context request-message coming from MS to SGSN, based on the required PDP type which in this case would be “raw IP”. This new PDP type might not support all the functionality normal PDP context supports; i.e. there would be no query to HLR for user information. After interception, the RNC allocates IP-address from its address space and returns successful Activate PDP Context response to MS. After this the “PDP Context” in RNC would support normal IP traffic, at least until SRNS relocation, in which case the “PDP Context” is deleted or possibly handed over.

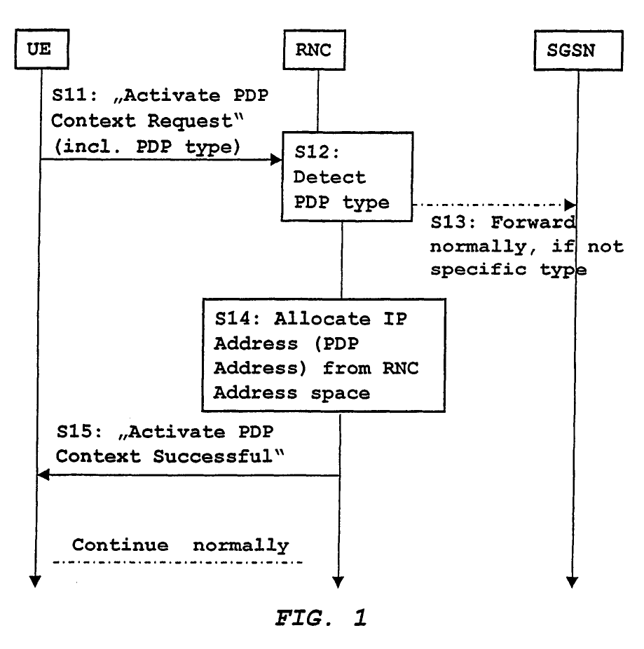

FIG. 1 illustrates in greater detail such a signaling scenario according to the first embodiment of the present invention.

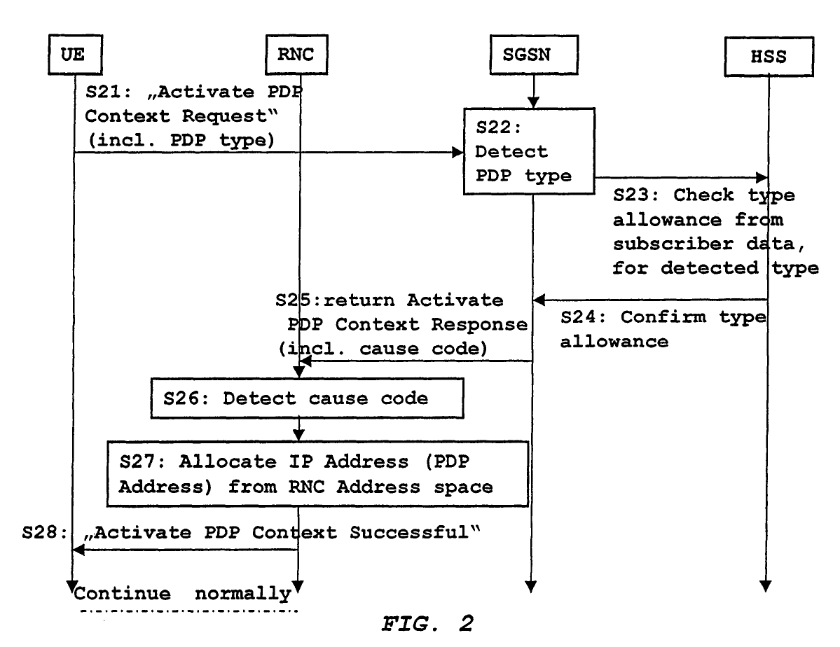

It is to be noted that in FIG. 1 as well as in FIG. 2 only those network nodes and/or entities involved when implementing the present invention are shown. The signaling forwarded and/or exchanged between these entities is illustrated by arrows in horizontal direction, while the sequence in time of the signaling and the processing performed at respective nodes is represented by the vertical sequence arrangement of the signaling arrows.

In an initial step S11 the terminal (e.g. a 3G user equipment UE) forwards an Activate PDP Context request (thus requesting for activation of a session management parameter) via the access network towards the core network, more particularly, the SGSN. The access network is here represented by a RNC. The forwarded signaling message also includes a requested PDP type to be activated.

The RNC in step S12 intercepts this signaling by which the RNC as an access network node is informed of a request for a session management parameter activation, and performs a detection of the PDP type included in the Activate PDP type request. If the PDP type is not a specific type (preset beforehand in the RNC), the RNC forwards in step S13 the (temporarily) intercepted Activate PDP Context Request further to the SGSN, as it is normal in Activate PDP context signaling scenarios.

If, however, the detection performed in step S12 yields that the PDP type included in the request is the specific type, the processing remains at the RNC side. This means that in this case, the RNC detects that said informed requested session management parameter activation relates to a specific type of session management parameter, and in step S14 the RNC continues processing by allocating an IP address (a PPD address) from its own address space to the requesting terminal UE (identified by e.g. its IMSI), thus allocating a network layer address to the terminal.

Thereafter, the RNC signals in step S15 “Activate PDP context successful” to the requesting terminal UE. From then onwards, the processing continuous as normal and need not be described here further.

### Second Embodiment

According to another option (second embodiment) the Activate PDP Context request is allowed to go—as in normal PDP context activation signaling scenarios—normally to the SGSN. There, the SGSN checks from subscriber information (obtained from HLR and/or HSS as a subscriber information database entity) that this type of specific PDP context type, e.g. “raw IP” type context is allowed for this user. Then SGSN returns Activate PDP Context Response to RNC with special cause code which would indicate failure in normal sense, but RNC would know that it is supposed to allocate the IP address from its address space and proceed like in embodiment 1 above.

FIG. 2 illustrates in greater detail such a signaling scenario according to the second embodiment of the present invention.

In an initial step S21 the terminal (e.g. a 3G user equipment UE) forwards an Activate PDP Context request (thus requesting for activation of a session management parameter) via the access network towards the core network, more particularly, the SGSN. The access network is here represented by a RNC. The forwarded signaling message also includes a requested PDP type to be activated.

The SGSN in step S22 detects this signaling request and performs a detection of the PDP type included in the Activate PDP type request. If the detected type is the specific PDP type, the SGSN issues a query, step S23, to a subscriber information database of the core network such as the home subscriber server HSS. By means of this query and/or inquiry, it is checked whether the type requested is allowed for the respective requesting subscriber. If the HSS database finding yields that the requested type is allowed for the requesting subscriber, the allowance of requesting this PDP type is confirmed in step S24 from the HSS to the querying SGSN. (If not, a corresponding notification is sent to the SGSN and the activation procedure terminates, e.g. with a further error notification (not shown) to the user equipment).

The confirmation for the requested specific PDP type being allowed is relayed, step S25, from the SGSN further to the RNC as a Return Activate PDP Context Response (including a code indicating the code for returning this to the RNC, i.e. representing the allowance of the requested type for the terminal). Thereby, the informing the access network node of a request for a session management parameter activation is achieved.

Subsequently, the RNC detects in step S26 the indicated cause code corresponding to the allowed specific requested PDP type, and in response thereto starts in step S27 to allocate an IP address (PDP address as a network layer address) to the requesting terminal (similar to step S14 in FIG. 1). If in step S26 the correct cause code is not received, the process continues with an error indication that the requesting terminal is not allowed to activate the requested PDP context having the specific type, i.e. the specific type of the session management parameter.

Then, in step S28, the RNC sends an Activate PDP context Successful message to the terminal/user equipment, similar as step S15 in FIG. 1, and the further procedure continues as normal.

### Third Embodiment

Optionally, the first and second embodiments could be combined such that the RNC having intercepted the Activate PDP context request and having checked that the PDP type is the specific one, queries the HSS/HLR (transparently or non-transparently) via the SGSN/GGSN in order to verify/check that the specific PDP type is allowed for the requesting subscriber. If yes, the HSS returns a confirmation to the RNC (transparently or non-transparently via the SGSN/GGSN), and the RNC continues to allocate the PDP addresses (network layer addresses, IP addresses) from its own address space, as in the previous embodiments.

Of course it is to be understood that the present invention also relates to correspondingly adapted network nodes, i.e. radio network controller nodes as well as SGSN nodes, which are adapted to receive and transmit the above described messages and to perform the processing/analysis of the messages and the contents thereof as described above.

Accordingly, as has been described herein above, the present invention relates to a method for session management parameter activation for a subscriber terminal of a communication network, the communication network comprising an access network via which said terminal accesses a core network, the core network being independent of the connection technology of the access network, said session management parameter comprises at least a network layer address of said subscriber terminal, the method comprising the steps of: informing S11; S25 an access network node of a request for a session management parameter activation, detecting S12; S26 at said access network node that said informed requested session management parameter activation relates to a specific type of session management parameter, and in response thereto, allocating S14; S27 a network layer address for said subscriber terminal from an address space maintained at said access network node.

Although the present invention has been described herein above with reference to its preferred embodiments, it should be understood that numerous modifications may be made thereto without departing from the spirit and scope of the invention. It is intended that all such modifications fall within the scope of the appended claims.

1. A method for
session management parameter activation for a subscriber terminal (UE) of a communication network,
the communication network comprising
an access network (RNC)
via which said terminal (UE) accesses a core network (SGSN),
the core network being independent of the connection technology of the access network,
said session management parameter comprises at least a network layer address of said subscriber terminal,
the method comprising the steps of:
informing (S11; S25) an access network node of a request for a session management parameter activation,
detecting (S12; S26) at said access network node that said informed requested session management parameter activation relates to a specific type of session management parameter, and in response thereto,
allocating (S14; S27) a network layer address for said subscriber terminal from an address space maintained at said access network node.

2. A method according to claim 1, wherein said step of informing comprises
receiving (S11) a session management parameter activation request from a terminal.

3. A method according to claim 1, wherein said step of informing comprises
receiving (S25) an indication for a session management parameter activation request from a core network node.

4. A method according to claim 1, wherein said access network node is a radio network controller (RNC).

5. A method according to claim 3, wherein said core network node is a serving GPRS support node (SGSN).

6. A method according to claim 2, wherein
said session management parameter activation request comprises at least the type of said session management parameter, and
said step of detecting (S12; S26) comprises
verifying that said received type of said requested session parameter activation is said specific type.

7. A method according to claim 3, wherein
said received indication (S25) confirms that said requested session parameter activation is related to said specific type.

8. A method according to claim 3 or 7, wherein
said indication is obtained as a result (S24) of an inquiry (S23) to a subscriber information database entity (HSS) and indicates that the requested type is allowed for the requesting subscriber.

9. A method according to claim 1, wherein said session management parameter is a PDP context for said subscriber terminal.
